(19) United States
(12) Patent Application Publication
(10) Pub. No.: US 2005/0175531 A1
(43) Pub. Date: Aug. 11, 2005

(54) Method for producing hydrogenous gases

(76) Inventors: Helge Wessel, Mannheim (DE); Markus Holzle, Kirchheim (DE); Klaus Harth, Altleiningen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/514,557

(22) PCT Filed: Jun. 6, 2003
(86) PCT No.: PCT/EP03/05938

(30) Foreign Application Priority Data
Jun. 11, 2002 (DE) 102 25 945.3

(51) Int. Cl. C01B 3/26

(52) U.S. Cl. 423/651; 502/343

(57) ABSTRACT

Hydrogenous gases are prepared by reacting hydrocarbons with air and/or water at temperatures of from 300 to 1000° C. and a pressure of from 1 to 20 bar in the presence of a catalyst by using a spinel catalyst which comprises at least one element of transition group VIII of the periodic table.

The present invention relates to a process for preparing hydrogenous gases by reacting hydrocarbons with air and/or water at elevated temperatures.

EP-A-1 157 968 discloses a process for autothermal steam reforming of hydrocarbons (preparation of hydrogenous gases) over catalyst compositions which comprise at least one platinum group metal on an oxidic support or on a zeolite.

These catalysts leave something to be desired in their activity and selectivity.

It is an object of the present invention to remedy the abovementioned disadvantages.

We have found that this object is achieved by a novel and improved process for preparing hydrogenous gases by reacting hydrocarbons or alcohols with water at temperatures of from 300 to 1000° C. and a pressure of from 1 to 20 bar in the presence of a catalyst, wherein the catalyst used is a spinel.

The process according to the invention may be carried out as follows:

In the reaction chamber, the hydrocarbon or the alcohol and water may be reacted at temperatures of from 300 to 1000° C., preferably from 400 to 750° C., more preferably from 450 to 700° C., and a pressure of from 1 to 20 bar, preferably from 1 to 10 bar, more preferably from 1 to 5 bar, in the presence of a catalyst according to the invention. The reaction mixture of hydrocarbon, air and/or water may be introduced into the reaction chamber without preheating or preferably preheated (for example to from 100 to 600° C.). A particular embodiment consists in generating the temperature required for preparing hydrogenous gases by partial oxidation of the hydrocarbon using oxygen, preferably air, and only then adding the reactant stream of water (autothermal steam reforming).

The hydrocarbons may be any desired hydrocarbons, for example crude oil, natural gas, petroleum, diesel, liquefied gas, propane or waste hydrocarbons from chemical processes. These hydrocarbons should be substantially sulfur-free.

Useful catalysts according to the invention are spinels, preferably any aluminum spinels, more preferably spinels of the general formula MₓAl₂O₄ where M is Cu or mixtures of Cu with Zn or of Cu with Mg and x is a value from 0.8 to 1.5, preferably from 0.9 to 1.2, more preferably from 0.95 to 1.1. These spinels generally comprise from 0 to 5% by weight, preferably from 0 to 3.5% by weight, of free oxides in crystalline form such as MO (M is, for example, Cu, Zn or Mg) and Al₂O₃.

The catalysts according to the invention show advantageous ageing behavior, i.e. the catalyst remains active for a long time without being thermally deactivated.

The catalysts according to the invention comprise copper in oxidic form, calculated as copper oxide CuO, in an amount of from generally 0 to 54% by weight, preferably from 5 to 40% by weight, more preferably from 10 to 30% by weight, based on the entire catalyst.

The catalyst according to the invention may comprise further dopants, in particular Zr, La, Ti, Ce or mixtures thereof in oxidic form. Doping with Zr, La or mixtures thereof generally increase the thermal stability of the catalysts according to the invention.

The content of doping compounds in the catalyst according to the invention is generally from 0.01 to 10% by weight, preferably from 0.05 to 2% by weight.

The catalyst according to the invention may additionally comprise further metallic active components. Such metallic active components are preferably metals of transition group VIII of the periodic table, more preferably palladium, platinum, ruthenium or rhodium, in particular rhodium. The content of the metals of transition group VIII in the catalyst according to the invention is generally from 0.01 to 7.5% by weight, preferably from 0.1 to 2% by weight.

The supported catalysts according to the invention may be in the form of pellets, honeycombs, rings, spall, solid and hollow extrudates or else in other geometric shapes, preferably in the form of honeycomb structures.

The catalysts according to the invention may be prepared from oxidic starting materials or from starting materials which are converted to the oxidic form in the subsequent calcining. They may be prepared by a process in which the starting materials comprising Al, Cu and optionally Zn and/or Mg and optionally further additives are mixed in one step, shaped into shaped bodies and optionally treated at temperatures of above 500° C.

In one possible embodiment of the process, a mixture of the starting materials may be processed to corresponding shaped bodies, for example by drying and tableting. These may then, for example, be heated to temperatures of from 500 to 1000° C. for from 0.1 to 10 hours (calcining). Alternatively, water may be added to prepare a deformable mass in a kneader or Mix-Muller which is extruded to give corresponding shaped bodies. The damp shaped bodies may be dried and subsequently calcined as described above.

The catalysts according to the invention may be prepared by a process which comprises the following steps:
a) preparation of an oxidic aluminic shaped body which may optionally comprise Cu and/or further doping metals,
b) saturation of the shaped body with soluble metal salts,
c) subsequent drying and calcining.

All preparative methods are conceivable which are known to those skilled in the art and may be applied to preparing the catalysts according to the invention:

For example, a support may be prepared from Cu in the form of Cu(NO₃)₂ and/or CuO and an aluminum component. When preparing the support, the starting materials may be mixed, for example, dry or with the addition of water. Zinc and/or magnesium components may be applied to the support by a single or repeated saturation. The catalysts according to the invention are obtained after drying and calcining at temperatures of from 500 to 1000° C., preferably from 600 to 950° C.

Copper may be used as a mixture of, for example, CuO and Cu(NO₃)₂. The catalysts prepared in this manner have a higher mechanical stability than the catalysts prepared only from CuO or only from Cu(NO₃)₂. Preference is further given to optionally using corresponding mixtures of oxides and nitrates of Zn and/or Mg. Instead of oxides and nitrates, pure oxides may also be used when acidic deforming assistants such as formic acid or oxalic acid are additionally added. Particularly when preparing the catalysts according to the invention in one step in which all starting materials are mixed and further processed to give shaped bodies, it is very advantageous to use mixtures of oxides and nitrates.

A useful aluminum component is a mixture of Al₂O₃ and AlOOH. Suitable aluminum components are described in EP-A-652 805.

Furthermore, metals of transition group VIII of the periodic table such as Pd, Pt, Ru and Rh are applied to the catalysts. These elements may be applied by known preparation methods, for example by saturation, precipitation, electroless deposition, CVD methods or vapor deposition. Preference is given to applying these noble metals in the form of their nitrates by a saturation step. After the saturation, the decomposition at temperatures of from 200 to 1000° C. and optional reduction are effected to give the elemental noble metal. Other known processes may also be utilized for applying the noble metals.

The process according to the invention is suitable for obtaining hydrogen in reformer units. The process according to the invention is only a part of the overall process for obtaining hydrogen for fuel cells. As well as the reforming of hydrocarbons, the overall process also comprises process stages for removing carbon monoxide from the hydrogenous reformate stream by, for example, one or more water gas shift stages and optionally a selective oxidation. The process stages for removing carbon monoxide are disclosed, for example, by WO-A-00/66486, WO-A-00/78669 and WO-A-97/25752.

### EXAMPLES

### Example A

Preparation of the Spinel Catalyst

A mixture of 1978.3 g of Puralox® SCF (from Condea), 1185.9 g of Pural® SB (from Condea), 1942 g of Cu(NO₃)₂×3 H₂O and 47 g of CuO were mulled for 30 min with 1.5% by weight of formic acid in 400 g of water, extruded to give honeycomb structures (600 cpsi \hat{=} cells per square inch), dried at 120° C. to constant weight and calcined at 800° C. for 4 hours. The honeycomb structure was then impregnated in accordance with its water takeup with Rh(III) nitrate solution (from Heraeus) so that an Rh content of 2% by weight resulted. Finally, the catalyst was calcined at 900° C. for 2 hours.

### Example B

Preparation of the comparative catalyst in analogy to Catalysis Letters 59, (1999) 121 to 127.

In analogy to the preparation described in Catalysis Letters 59 (1999) on page 121 ff, a comparative catalyst was prepared which had the following composition:
5% by weight of rhodium, 95% by weight of Al₂O₃

### Example 1

Autothermal Reforming of Methane

In a reactor, 510 liters of methane and 1210 liters of air were each heated to 500° C. and passed over 28 ml of the catalyst prepared according to example A in order to initially preheat it to the required operating temperature (gas exit temperature from 670 to 710° C.) by catalytic partial oxidation. 510 liter/h of methane, 1210 liter/h of air and 1020 liter/h of steam were then metered into the reactor in stationary operation.

When the catalyst of example A was used, the dry reformate comprised 47% by volume of hydrogen, 5% by volume of carbon monoxide, 13% by volume of carbon dioxide and 35% by volume of nitrogen.

When the catalyst of example B was used, the dry reformate comprised 39% by volume of hydrogen, 14% by volume of carbon monoxide, 7% by volume of carbon dioxide, 37% by volume of nitrogen and 3% by volume of methane.

| | | TABLE | | | | | |
|---|---|---|---|---|---|---|---|
| | | Running time [hours] | | | | | |
| Catalysator | | 250 | 500 | 750 | 1000 | 1250 | 1500 |
| A | CH₄ | 100 | 100 | 99 | 99 | 100 | 98 |
| | conversion [%] | | | | | | |
| A | H₂ productivity | 48 | 49 | 47 | 47 | 48 | 47 |
| | m²_{H2} at | | | | | | |
| | STP/cat * h | | | | | | |
| B | CH₄ | 93 | 92 | 90 | 88 | 85 | 81 |
| | conversion [%] | | | | | | |
| B | H₂ productivity | 36 | 34 | 34 | 32 | 29 | 25 |
| | m²_{H2} at | | | | | | |
| | STP/cat * h | | | | | | |

1. A process for preparing hydrogenous gases comprising reacting a hydrocarbon with air and/or water at temperatures of from 300 to 1000° C. and a pressure of from 1 to 20 bar in the presence of a catalyst, wherein the catalyst comprises a spinel of the general formula MₓAl₂O₄ where M is Cu or a mixture of Cu with Zn or of Cu with Mg and x is from 0.8 to 1.5 and further comprises up to 5% by weight of free oxides in crystalline form and at least one element of transition group VIII of the periodic table.

2. A process for preparing hydrogenous gases as claimed in claim 1, wherein the element of transition group VIII of the periodic table is rhodium.

3. A process for preparing hydrogenous gases as claimed in claim 1, wherein the hydrocarbon is an aliphatic and/or aromatic hydrocarbon.

4. A process for preparing hydrogenous gases as claimed in claim 1, wherein the hydrocarbon is methane.

5. A process for preparing hydrogenous gases as claimed in claim 1, wherein the hydrocarbon is natural gas.

6. A catalyst for preparing hydrogenous gases by reacting hydrocarbons with air and/or water at temperatures of from 300 to 1000° C. and a pressure of from 1 to 20 bar comprising a spinel of the general formula MₓAl₂O₄ where M is Cu or mixtures of Cu with Zn or Cu with Mg and x is from 0.8 to 1.5 and further comprising up to 5% by weight of free oxides in crystalline form and at least one element of transition group VIII of the periodic table.

7. A process for obtaining hydrogen for fuel cells, comprising producing hydrogen by a process as claimed in claim 1.

8. A process for obtaining hydrogen for fuel cells. comprising producing hydrogen by a process as claimed in claim 1 and further comprising removing carbon monoxide from hydrogen by at least one upstream process stage for removing carbon monoxide.

9. A process for preparing hydrogenous gases as claimed in claim 1 wherein the hydrocarbon is a mixture of hydrocarbons, a petroleum oil, a petrol, a diesel oil or a petroleum oil distillate.
